(19) United States
(12) Patent Application Publication
(10) Pub. No.: US 2025/0138331 A1
(43) Pub. Date: May 1, 2025

(54) IMAGING OPTICAL SYSTEM AND MEASURING DEVICE

(71) Applicant: CANON VIRGINIA, INC., Newport News, VA (US)

(72) Inventors: Ryota Sato, Sakura (JP); Hiroto Kano, Utsunomiya (JP)

(21) Appl. No.: 18/932,329

(22) Filed: Oct. 30, 2024

Related U.S. Application Data
(60) Provisional application No. 63/594,733, filed on Oct. 31, 2023.

(51) Int. Cl. G02B 27/42; G02B 27/01; G02B 27/28

(52) U.S. Cl. CPC G02B 27/4261; G02B 27/0101; G02B 27/283; G02B 27/4205; G02B 27/4272

(57) ABSTRACT

Provided are an imaging optical system and measurement device for guiding light reflected from a retina to at least one imaging device, the system and device having a first polarization-selective diffractive (PSD) optical element and a second PSD optical element, with the retina, the first PSD optical element, and the second optical PSD element are positioned along an optical path. When emitted by the first PSD optical element, the light is diffracted by a first diffraction angle and, when emitted by the second PSD optical element, the light is diffracted by a second diffraction angle that is opposite to the first angle.

### CROSS-REFERENCE TO RELATED APPLICATIONS

The present application claims benefit of and priority to U.S. provisional application No. 63/594,733 filed Oct. 31, 2023, the disclosure of which is hereby incorporated by reference in its entirety for all purposes. Priority benefit is claimed under 35 U.S.C. § 119(e).

### BACKGROUND INFORMATION

### Field of Disclosure

The present disclosure relates to an imaging optical system and a measuring device equipped with the same.

### Description of Related Art

In the human eye, the fovea exists in the center of the macula of the retina, and it is known that the best visual acuity is achieved in the fovea. It is also known that by detecting the birefringence state caused by the Henle fibers radiating from the fovea, it is possible to determine where the subject is staring (fixation state).

U.S. Pat. Nos. 6,027,216A and 9,675,248 B2 disclose a fixation inspection device having a projection device that projects a projection image onto the retina of the eye and a photodetector that acquires a reflection image showing the fixation state of the eye reflected by the retina. Patent Document 1 proposes a method to detect the fixation state by separating the reflected light of the light irradiated to the retina of the eye with a polarizing beam splitter (PBS) and then detecting each polarization component. In addition, U.S. Pat. No. 9,675,248 B2 proposes a method that simultaneously detects the fixation state of both eyes by polarizing light using a lens, prism, etc.

However, in U.S. Pat. No. 6,027,216A, in order to acquire each polarization component of both eyes separately, a PBS and a plurality of detection (sensor) units are required, resulting in an enlarged optical system. In addition, in U.S. Pat. No. 9,675,248 B2, a plurality of detection units similar to U.S. Pat. No. 6,027,216A, or a prism or the like to realize one detection unit is required, resulting in an enlarged optical system.

Therefore, there is desired a miniaturization and improvement of measurement accuracy in an imaging optical system and a measurement device. To overcome the shortcomings of conventional systems, provided are miniaturized imaging optical systems and measurement devices that provide improved measurement accuracy.

### SUMMARY

An aspect of the disclosure provides an imaging optical system for guiding light reflected from a retina to at least one imaging device, with the imaging optical system including a first polarization-selective diffractive (PSD) optical element; and a second PSD optical element, with the retina, the first PSD optical element, and the second optical PSD element being positioned along an optical path. When emitted by the first PSD optical element, the light is diffracted by a first diffraction angle and, when emitted by the second PSD optical element, the light is diffracted by a second diffraction angle that is opposite to the first angle.

Another aspect of the present disclosure provides an imaging optical system for guiding light reflected from a retina to at least one imaging device, with the imaging optical system including a first optical system having a positive refractive power; a first polarization-selective diffractive (PSD) optical element; a second optical system having a positive refractive power; and a second PSD optical element. The retina, the first optical system, the first PSD optical element, the second PSD element, and the second optical system are arranged in order along an optical path.

### BRIEF DESCRIPTION OF THE DRAWINGS

The accompanying drawings, which are incorporated herein and form part of the specification, illustrate various embodiments, objects, features, and advantages of the present disclosure.

FIG. 1 shows the XZ cross section view of the imaging optical system 1 according to numerical example 1.

FIG. 2 shows the YZ cross section view of the imaging optical system 1 according to numerical example 1.

FIG. 3A shows a PSD element and diffracted light (without wavelength plate) according to the present disclosure.

FIG. 3B shows a PSD element and diffracted light (with wavelength plate) according to the present disclosure.

FIG. 3C shows two PSD elements and diffracted light (with wavelength plate) according to the present disclosure.

FIG. 3D shows two PSD elements and diffracted light (without wavelength plate) according to the present disclosure.

FIG. 4 shows the details of polarization by a PSD element according to the present disclosure.

FIG. 5A shows the second optical system LE2 (with aperture inclination) according to numerical example 1.

FIG. 5B shows the second optical system LE2 (without aperture inclination) according to numerical example 1.

FIG. 6A shows the XZ cross section of the measuring device according to numerical example 1.

FIG. 6B shows the YZ cross section of the measuring device according to numerical example 1.

FIG. 7A shows the XZ cross section of the optical path (1-1^{st} order light) of the imaging optical system 1 according to numerical example 1.

FIG. 7B shows the YZ cross section of the optical path (1-1^{st} order light) of the imaging optical system 1 according to numerical example 1.

FIG. 8 shows the YZ cross section of the optical path (unnecessary light) of the imaging optical system 1 according to numerical example 1.

FIG. 9A shows the XZ cross section of the optical path (1-1^{st} order light) of the imaging optical system 1 according to numerical example 2.

FIG. 9B shows the YZ cross section of the optical path (1-1^{st} order light) of the imaging optical system 1 according to numerical example 2.

FIG. 10 shows the YZ cross section of the optical path (unnecessary light) of the imaging optical system 1 according to numerical example 2.

FIG. 11A shows the XZ cross section of the optical path (1-1^{st} order light) of the imaging optical system 1 according to numerical example 3.

FIG. 11B shows the YZ cross section of the optical path (1-1^{st} order light) of the imaging optical system 1 according to numerical example 3.

FIG. 12 shows the YZ cross section of the optical path (unnecessary light) of the imaging optical system 1 according to numerical example 3.

FIG. 13 shows a block diagram of the fixation inspection device according to the present disclosure.

Throughout the figures, the same reference numerals and characters, unless otherwise stated, are used to denote like features, elements, components or portions of the illustrated embodiments, and duplicate descriptions are omitted. Each drawing may, for convenience sake, be drawn on a scale different from the actual scale. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

An embodiment of the present disclosure will be described below with reference to the drawings. Each drawing may, for the sake of convenience, be drawn with a scale different from the actual scale. In addition, in each drawing, the same components are assigned the same reference numbers, and duplicate descriptions are omitted.

### Embodiment 1

The optical system according to embodiment 1 of the present disclosure will be described in detail below.

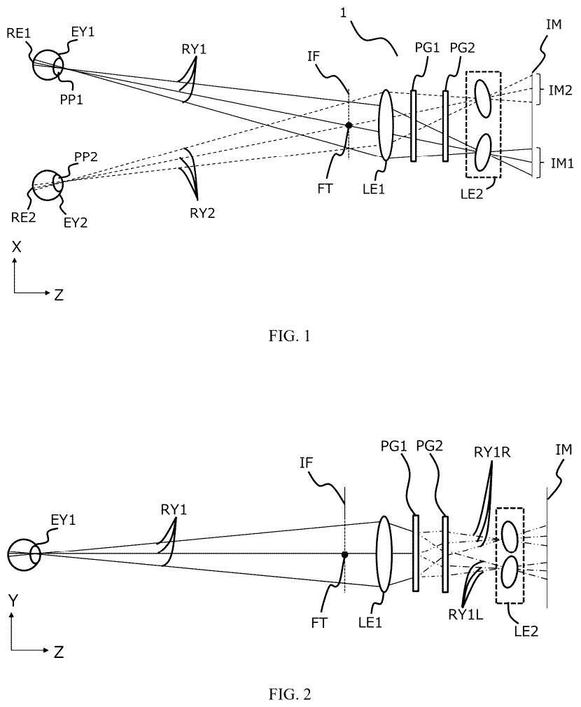

FIG. 1 is an XZ cross-sectional view of the imaging optical system 1 according to embodiment 1 of the present disclosure. The imaging optical system 1 is a device that measures the fixation state of the eyes EY1 and EY2. The imaging optical system 1 is composed of a first optical system LE1, a first polarization-selective diffractive optical element (hereinafter, referred to as “PSD element”) PG1, a second PSD element PG2, and a second optical system LE2. The imaging surface IM corresponds to a light-receiving surface of an imaging device such as a CCD (Charge Coupled Device) sensor or a CMOS (Complementary Metal Oxide Semiconductor) sensor. The retinae RE1 and RE2 of the eyes EY1 and EY2 are conjugated to the intermediate image IF, and the intermediate image IF is conjugated to the imaging plane (image plane) IM via the imaging optical system 1. In addition, to guide the subject's fixation point, a fixation target FT is arranged at a position conjugate to the optical path center of this intermediate image IF. The fixation target FT may be a marker made by an LED that is a self-luminous element, an organic EL element or a liquid crystal display element having back illumination, or the like.

Light reflected from the retina RE1 is shown with RY1 (solid lines), and light reflected from the retina RE2 is shown with RY2 (dashed lines). After the reflected light RY1 is imaged once at the intermediate image IF position, it is imaged at the imaging position IM1 of the imaging surface IM by the imaging optical system 1. In addition, after the reflected light RY2 is imaged once at the intermediate image IF position, it is imaged at the imaging position IM2 of the imaging surface IM by the imaging optical system 1. The second optical system LE2 is composed of an array optical system composed of two or more lenses, and each optical system is arranged in an approximately conjugate position with respect to the pupil (lens) PP1 of the eye EY1 and the pupil PP2 of the eye EY2, respectively. Both the first optical system LE1 and the second optical system LE2 have positive refractive power.

Here, the first optical system LE1 and the second optical system LE2 may be each composed of one optical element (e.g., a lens) or a plurality of optical elements. In addition, reflecting elements such as mirrors may be employed as part of the first optical system LE1 and the second optical system LE2.

FIG. 2 is a view showing the imaging optical system 1 in the YZ plane according to embodiment 1 of the present disclosure. After the reflected light RY1 from the eye EY1 is imaged once at the intermediate image IF position, it is diffracted by the diffraction planes of the first PSD element PG1 and the second PSD element PG2, respectively. Due to the polarization state of the reflected light RY1, it is separated into the reflected light RY1R and the reflected light RY1L, and each is imaged on the imaging surface IM. On the other hand, the reflected light RY2 from the eye EY2 (not shown) is also separated into two reflected lights as reflected light RY2R and reflected light RY2L due to its polarization state same as the reflected light RY1. Here, all images guided from reflected light RY1R, RY1L, RY2R and RY2L can be imaged by a single imaging device, or can be imaged separately by multiple imaging devices. The second optical system LE2 is arranged so that it guides the reflected light RY1 and RY2 separated into two luminous fluxes respectively by the PSD element PG1 and PG2 to the imaging surface IM.

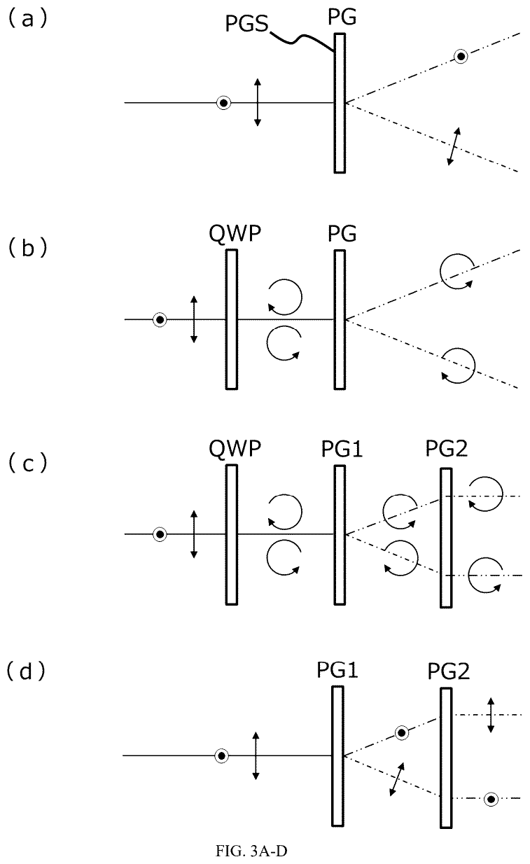

FIG. 3 is a view showing a PSD element constituting the imaging optical system 1 of the present disclosure. FIG. 3A shows one form of a PSD element. The incident light from the left in FIG. 3A is diffracted by the diffraction plane PGS of the PSD element PG, and the light is guided to the upper right for the polarized component of the deep-front direction and to the lower right for the polarized component of the up-down direction. Normally, the diffraction angle of the PSD element PG is 20 degrees, and it is possible to guide the light of each separated polarized component to the right together. Therefore, unlike the PGS, which separates the polarized components via transmission and reflection, it is possible to image an optical image by each polarized component without arranging a plurality of imaging devices. As a result, the size of the optical system is expected to decrease. The diffraction angle of each of the PSD elements in FIG. 3A are almost identical, but different diffraction angle may also be used. In this embodiment, the diffraction plane PGS of the PSD element is formed on the incident plane side, but may also be formed on the exit plane side.

The PSD elements in FIG. 3B show devices with different diffraction directions depending on the rotation direction of circularly polarized light. A quarter-wave plate QWP may be arranged in front of these PSD elements to separate the polarized components in a similar manner to those in FIG. 3A.

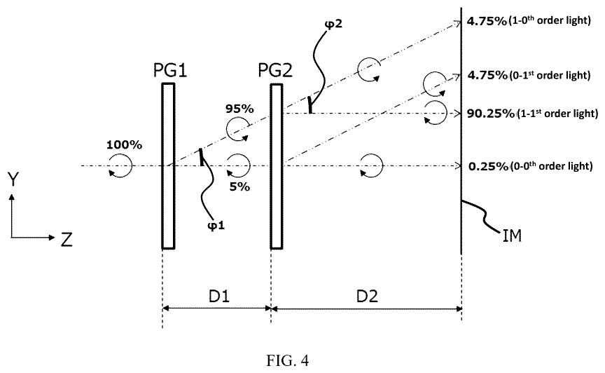

FIG. 3C shows a configuration including two PSD elements PG1 and PG2 in this embodiment. The polarized components in the deep-front direction and up-down direction enter into the quarter-wave plate QWP and convert into circular polarized components that differ from each other. Next, they are diffracted in different directions for each rotational direction of circularly polarized light by the first PSD element PG1. In addition, they are diffracted in the opposite direction (angle of opposite sign) from the diffraction direction by the first PSD element, while being converted into circularly polarized light in the opposite direction of each of the incident circularly polarized light components by the second PSD element PG2. In other words, the angle (the angle formed by the incident ray and the diffracted outgoing ray with respect to the incident ray) at which light in a certain polarized state (first polarized state) is diffracted by the first PSD element PG1 is defined as ø1. The angle at which light in this polarized state is diffracted by the first PSD element PG1 and emitted light is diffracted by the second PSD element PG2 is defined as ø2. At this time, as shown in FIG. 4, ø1 and ø2 are opposite signs to each other. Note that, as shown in FIG. 3D, it may also be a configuration in which it is separated as linearly polarized light without including a quarter-wave plate QWP. In this case, achieving further miniaturization by reducing the number of devices becomes possible.

A more specific configuration will be explained. FIG. 4 omits the description of the quarter-wave plate QWP and shows a state in which only the circularly polarized light, which is clockwise relative to the paper surface, is incident on the first PSD element PG1. Ideally, a PSD element is formed so that all of the incident light diffracts in the first order, but in reality, a small amount of zero-order diffraction components (light that was not diffracted) remain due to manufacturing errors, etc. If components other than diffracted light required for inspection, especially different polarized components, are made incident on the imaging surface IM, inspection accuracy will degrade.

Therefore, in this embodiment, as shown in FIG. 4, when a small amount (e.g., 5%) of the zero-order diffraction component remains by one PSD element, the configuration is such that only the diffracted light component (1-1^{st} order light; Here, the i-j-th order light means the light that is diffracted in the i-th order with PG1 is diffracted in the j-th order with PG2 and reaches the imaging plane IM.) necessary for inspection is focused near the optical axis, and the other unnecessary light (0-1^{st}, 1-0^{th} order light) component reaches a position away from the optical axis. With this configuration, both the miniaturization of the light receiving part and the improvement of inspection accuracy are achieved. Although the 0-0^{th} order light component reaches the optical axis, it can be ignored because the amount of light is relatively small compared to the 1-1^{st} order light to be detected and the effect on inspection accuracy is small.

For the clockwise circularly polarized light incident on the first PSD element PG1, 95% is branched as first-order diffracted light and 5% as zero-order diffracted light respectively. At this time, the first-order diffracted light is converted from clockwise circularly polarized light when it enters PG1 to counterclockwise circularly polarized light. When the polarized light diffracted in the first order enters the second PSD element PG2, similarly, 95% of the light arrives at the imaging plane IM while being converted into clockwise circularly polarized light and diffracted in the first order (1-1^{st} order light), and the light diffracted in the 0 order arrives at the imaging plane IM as is (1-0^{th} order light). In addition, similarly, for the component diffracted in the 0 order by the first PSD element PG1, after entering the second PSD element PG2, 95% arrives at the imaging plane IM as counter-clockwise polarized light (0-1^{th} order) and 5% arrives at the imaging plane IM as is (0-0^{th} order light).

As described above, due to the diffraction at each PSD element, the 1-1^{th} order light necessary for inspection and the 0-0^{th} order light which does not affect inspection arrives near the optical axis, and the 0-1^{th} order light and the 1-0^{th} order light which are not necessary for inspection arrive at positions separated from the optical axis. Thus, while improving the inspection accuracy, miniaturization of the imaging surface IM itself is also achieved.

As shown in FIG. 4, the angle formed by light incident on the first PSD element PG1 and diffracted light is defined as ø1, the angle formed by light incident on the second PSD element PG2 and diffracted light is defined as ø2, and the angle diffracted in the +Y direction is defined as positive.

FIG. 5 is a view showing the arrangement of a second optical system LE2 in the imaging optical system 1 of this embodiment. In FIG. 5A, OP1 represents the optical axis composed of the first optical system LE1, and OP2 and OP3 represent each optical axis of the second optical system LE2.

In FIG. 5A, the optical axes OP2 and OP3 have inclination eccentricity with respect to the optical axis OP1. Since the reflected light from both eyes and the diffracted light after passing through the PSD element are inclined with respect to the optical axis OP1 respectively, it is desirable that the optical axes OP2 and OP3 are inclined and eccentric along it. This facilitates aberration correction and is expected to reduce the size of the imaging optical system. The inclination amounts of the optical axes OP2 and OP3 with respect to the optical axis OP1 may be different.

In addition, the AP indicates an aperture stop. The aperture stop AP can be arranged between the second PSD element PG2 and the second optical system LE2. Thereby, it becomes possible to extract only the light components necessary for inspection while effectively preventing the unnecessary light generated by each PSD element. In addition, the aperture stop AP may be arranged perpendicular to the optical axes OP2 and OP3 as shown in FIG. 5A or perpendicular to the optical axis OP1 as shown in FIG. 5B.

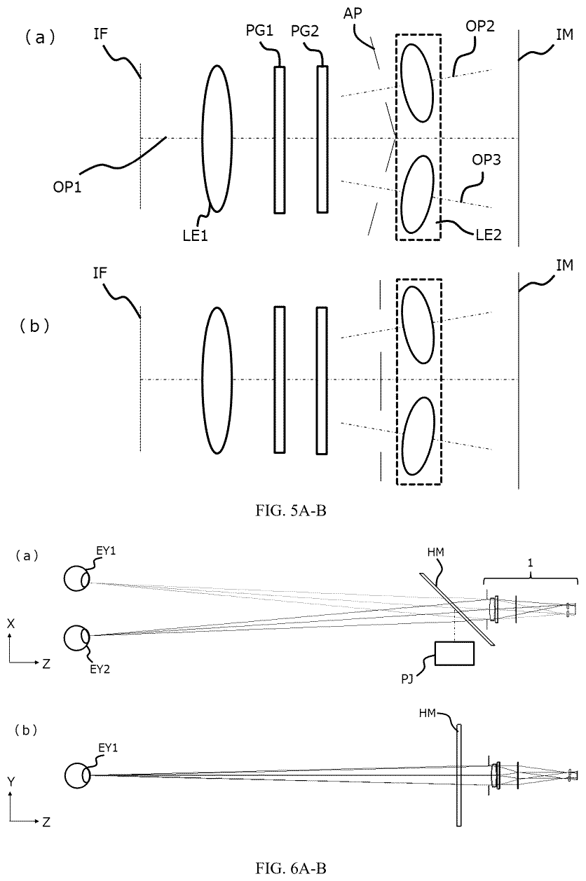

FIG. 6 is a view showing a measuring device according to an embodiment of the present disclosure. Illumination light from the illuminator PJ is reflected by a half-mirror HM and guided to the retina of eyes EY1 and EY2. The illumination image formed by the illuminator PJ is conjugate to the retina of the eyes EY1 and EY2. In addition, the wavelength of the light source (not shown) of the illuminator PJ can be in the range of 800˜900 nm, considering the absorption of light by water and the spectral luminous efficiency of the human eye. Because light measures the retina through the cornea, vitreous, and lens, it is absorbed and attenuated by water, which is the main component of these tissues. The transmittance of light to water is wavelength dependent and has a high transmittance in the wavelength range of approximately 200 nm to 900 nm. On the other hand, the human eye has a sensitivity characteristic for each wavelength of light called spectral luminous efficiency, which senses light from approximately 360 nm to 800 nm. For more stable measurements, one can avoid the above sensitivity range to prevent miosis of the human eye. Based on the above point of view, considering the absorption of water as well, light in the range of approximately 800 nm to 900 nm is desirable.

Reflected light from the retina passes through the half-mirror HM and is guided to the image device (COMS sensor, CCD sensor, etc.) by the imaging optical system 1. FIG. 6A shows the diffraction direction of the PSD element on the XZ plane and FIG. 6B on the YZ plane.

Next, a measurement device (fixation measurement device) OS1 will be described with reference to FIG. 13. FIG. 13 is a block diagram of the measurement device OS1. The measurement device OS1 images the reflected light from the retina of the eye of the subject by an imaging part 102, and judges whether the subject is viewing the fixation target FT with a visual axis consisting of the fovea and the center of the lens by analyzing changes related to the polarization between the incident light to the retina of the eye of the subject and the reflected light from the retina by an arithmetic part 103, and measures the fixation state of the subject.

The measurement device OS1 has an illumination part 101, an imaging part 102, and an arithmetic part 103. The illumination part 101 has a display surface or a light source such as an LED, a laser diode, etc., to guide the light toward the subject. The imaging part 102 has the imaging optical system and the imaging device described in embodiments 1 through 3. The imaging part 102 images the reflected light reflected from the retina (fundus) of the subject's eye. The imaging part 102 also images information related to the polarization of the incident light to the retina and the reflected light from the retina. The imaging part 102 also simultaneously images reflected light from the left and right eyes of the subject. The arithmetic part 103 is equipped with a means for measuring the fixation state of the subject based on information reflected from the retina of both eyes.

### EXAMPLES

### Numerical Example 1

Table 1 shows the specification values of numerical example 1, Table 2 shows the arrangement of the array optical system, and Table 3 shows the specification values of the PSD element. R denotes the radius of curvature of the i plane, D denotes the spacing between the i plane and the i+1 plane, and N_{d} denotes the refractive index between the i plane and the i+1 plane in the d-line. The radius of curvature R shall be positive if it is convex toward the intermediate image and negative if it is concave. The plane spacing D shall be positive in the direction from the intermediate image IF to the imaging plane IM. Moreover, v_{d} is obtained by the following formula:

$${v}_{d} = \frac{{N}_{d} − 1}{{N}_{F} − {N}_{C}}$$

Here, N_{F} denotes the refraction index in the F line and N_{C} denotes the refraction index in the C-line. In addition, the reference wavelength of each numerical example shall be 830 nm.

The incident plane centers AL1 to AL4 of each array optical system constituting the second optical system LE2 are respectively arranged at positions eccentric from the origin by a prescribed amount shown in Table 2, with the imaginary point shown in the LE2 R1 column of Table 1 as the origin. That is, the optical axis of each lens included in the array optical system is inclined with respect to the optical axis of the first optical system LE1. Note that only the plane spacing D of the array optical system LE2 R1 listed in Table 1 is the distance in the direction of the plane-normal considering the rotational eccentricity listed in Table 2.

Thereafter, although the optical surfaces of the first optical system LE1 and the second optical system LE2 in each numerical example are composed of spherical surfaces to be rotated, rotationally symmetric aspheric surfaces, anamorphic, and free-form surfaces may be adopted as necessary. In addition, cover glass, dustproof glass or the like may be arranged on the optical path. Folding by a reflecting surface or the like may be adopted according to the device layout.

TABLE 1

| Surf No | | R[mm] | D[mm] | Nd | ν d |
|---|---|---|---|---|---|
| 1 | IF | 0 | 2.50 | 1.00 | — |
| 2 | LE1 R1 | 55 | 5.00 | 1.77 | 49.60 |
| 3 | LE1 R2 | −130 | 1.00 | 1.00 | — |
| 4 | QWP R1 | 0 | 2.00 | 1.52 | 58.59 |
| 5 | QWP R2 | 0 | 0.20 | 1.00 | — |
| 6 | PG1 R1 | 0 | 0.45 | 1.52 | 55.00 |
| 7 | PG1 R2 | 0 | 18.00 | 1.00 | — |
| 8 | PG2 R1 | 0 | 0.45 | 1.52 | 55.00 |
| 9 | PG2 R2 | 0 | 50.00 | 1.00 | — |
| 10 | AP | 0 | 1.00 | 1.00 | — |
| 11 | LE2 R1 | 10 | 2.00 | 1.77 | 49.60 |
| 12 | LE2 R2 | −10 | 6.50 | 1.00 | — |
| 13 | IM | 0 | — | 1.00 | — |

TABLE 2

| | X Shift | Y Shift | X Axis | Y Axis |
|---|---|---|---|---|
| | [mm] | [mm] | Rot[deg] | Rot [de] |
| AL1 | 3.71 | 2.63 | 0.83 | −1.96 |
| AL2 | 3.71 | −2.63 | −0.83 | −1.96 |
| AL3 | −3.71 | 2.63 | 0.83 | 1.96 |
| AL4 | −3.71 | −2.63 | −0.83 | 1.96 |

TABLE 3

| | Diffraction | Lattice | Φ1 | Φ2 |
|---|---|---|---|---|
| | Direction | Pitch [um] | [deg] | [deg] |
| PG1 | Y | 6.00 | 7.96 | — |
| PG2 | Y | 6.00 | — | −7.96 |

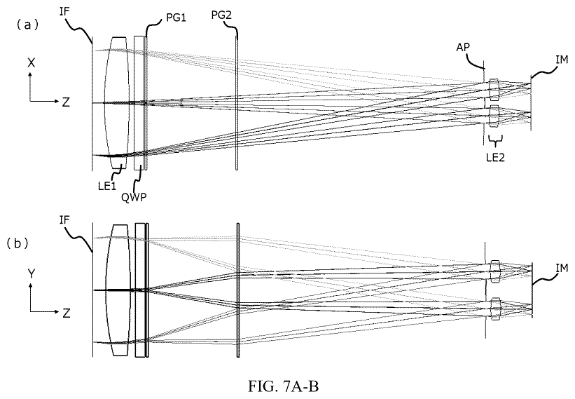

FIG. 7 shows an enlarged view of the optical path of the imaging optical system 1 including the 1-1^{st} order light in numerical example 1. FIG. 7A shows the XZ cross section and FIG. 7B shows the YZ cross section, and both polarized components are listed. Both the X direction and the Y direction achieve imagine formation on the imaging plane IM and near the optical axis.

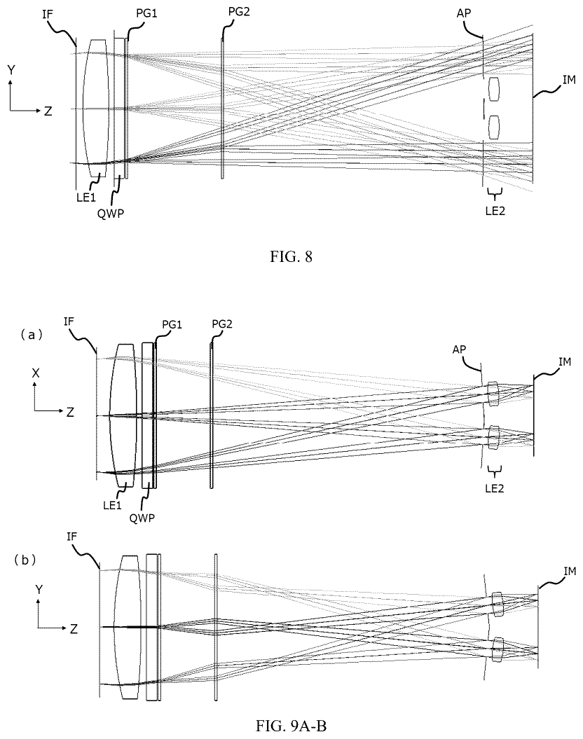

In addition, an enlarged view of the optical path of the imaging optical system 1 including the 0-1^{st} order light and the 1-0^{th} order light unnecessary for inspection is shown in FIG. 8. Similar to FIG. 7, it lists both polarized components. Most of the components arrive at positions away from the optical axis and are sufficiently separated from the 1-1^{st} order light required for inspection.

Based on the above, by adopting this embodiment, it is possible to realize miniaturization of the fixation inspection device and improvement of the measurement accuracy.

Below, exemplary conditions that can be used for each of the embodiments including this embodiment will be described.

$$- 2 < \frac{{∅}_{1}}{{∅}_{2}} < 0 \qquad ( 1 )$$

If the upper limit of conditional expression (1) is exceeded, the 1-1^{st} order light required for inspection arrives at a position on the outside even of the unnecessary light, and the sensor size or optical system increases in size.

If the lower limit of conditional expression (1) is exceeded, the 1-1^{st} order light required for inspection will be positioned between each unnecessary light, resulting in a deterioration of measurement accuracy because the light cannot be sufficiently separated.

In addition, for conditional expression (1), the following range can be set.

$$- 1 \leq \frac{{∅}_{1}}{{∅}_{2}} < 0$$

In numerical example 1, it is

$$\frac{{∅}_{1}}{{∅}_{2}} = - 1.0$$

$$0.1 \leq \frac{{D}_{1}}{{D}_{2}} \leq 2. \qquad ( 2 )$$

Here, D₁ denotes the distance from the diffraction plane of the first PSD element PG1 to the diffraction plane of the second PSD element PG2, and D₂ denotes the distance from the diffraction plane of the second PSD element PG2 to the imaging plane (light-receiving surface of the image device) IM.

If the upper limit of conditional expression (2) is exceeded, it becomes necessary to increase the diffraction angle at the second PSD element to separate it from unnecessary light. Alternatively, the distance in the optical axis direction becomes too long and the optical system can increase in size.

If the lower limit of conditional expression (2) is exceeded, it is necessary to increase the distance in the optical axis direction for separation from unnecessary light, and the optical system can increase in size.

In addition, conditional expression (2) should further be in the following range.

$$0.1 \leq \frac{{D}_{1}}{{D}_{2}} \leq 1.2$$

In numerical example 1, it is

$$\frac{{D}_{1}}{{D}_{2}} = 0.31$$

### Numerical Example 2

The measuring device according to numerical example 2 of the present disclosure will be described in detail below.

Table 4 shows the specifications of numerical example 2, Table 5 shows the arrangement of the array optical system, and Table 6 shows the specifications of the PSD element. The definition of each parameter is omitted because it is the same as in numerical example 1.

TABLE 4

| Surf No | | R[mm] | D[mm] | Nd | ν d |
|---|---|---|---|---|---|
| 1 | IF | 0 | 2.50 | 1.00 | — |
| 2 | LE1 R1 | 55 | 5.00 | 1.77 | 49.60 |
| 3 | LE1 R2 | −130 | 1.00 | 1.00 | — |
| 4 | QWP R1 | 0 | 2.00 | 1.52 | 58.59 |
| 5 | QWP R2 | 0 | 0.20 | 1.00 | — |
| 6 | PG1 R1 | 0 | 0.45 | 1.52 | 55.00 |
| 7 | PG1 R2 | 0 | 10.00 | 1.00 | — |
| 8 | PG2 R1 | 0 | 0.45 | 1.52 | 55.00 |
| 9 | PG2 R2 | 0 | 50.00 | 1.00 | — |
| 10 | AP | 0 | 1.00 | 1.00 | — |
| 11 | LE2 R1 | 10 | 2.00 | 1.77 | 49.60 |
| 12 | LE2 R2 | −10 | 6.50 | 1.00 | — |
| 13 | IM | 0 | — | 1.00 | — |

TABLE 5

| | X Shift | Y Shift | X Axis | Y Axis |
|---|---|---|---|---|
| | [mm] | [mm] | Rot[deg] | Rot[deg] |
| AL1 | 4.00 | 4.00 | −5.72 | −3.35 |
| AL2 | 4.00 | −4.00 | 5.72 | −3.35 |
| AL3 | −4.00 | 4.00 | −5.72 | 3.35 |
| AL4 | −4.00 | −4.00 | 5.72 | 3.35 |

TABLE 6

| | Diffraction | Lattice | | |
|---|---|---|---|---|
| | Direction | Pitch [um] | Φ1[deg] | Φ2[deg] |
| PG1 | Y | 8.30 | 5.75 | — |
| PG2 | Y | 4.15 | — | −11.50 |

FIG. 9 shows an enlarged view of the optical path of the imaging optical system 1 including the 1-1^{st} order light in numerical example 2. FIG. 9A shows the XZ cross section and FIG. 9B shows the YZ cross section, and both polarized components are listed. In addition, similarly to FIGS. 7 and 8, the illumination part PJ, the eyes EY1 and EY2, and the half mirror HM are omitted. Both the X direction and the Y direction achieve image formation on the imaging plane IM and near the optical axis.

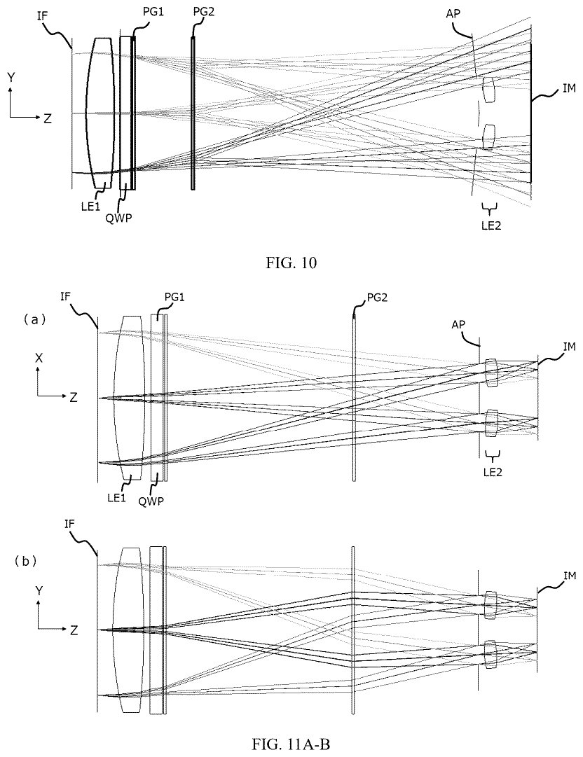

Furthermore, an enlarged view of the optical path of the imaging optical system 1 including the 0-1^{st} order light and the 1-0^{th} order light not required for inspection is shown in FIG. 10. Similar to FIG. 9, both polarized components are listed. Most of the components arrive at positions away from the optical axis and are sufficiently separated from the 1-1^{st} order light required for inspection.

In numerical example 2, it is

$$\frac{{∅}_{1}}{{∅}_{2}} = - 0.5 \frac{{D}_{1}}{{D}_{2}} = 0.17 .$$

### Numerical Example 3

The measuring device according to numerical example 3 of the present disclosure will be described in detail below.

Table 7 shows the specifications of numerical example 3, Table 8 shows the arrangement of the array optical system, and Table 9 shows the specifications of the PSD element. The definition of each parameter is omitted because it is similar to numerical examples 1 and 2.

TABLE 7

| Surf No | | R[mm] | D[mm] | Nd | ν d |
|---|---|---|---|---|---|
| 1 | IF | 0 | 2.50 | 1.00 | — |
| 2 | LE1 R1 | 55 | 5.00 | 1.77 | 49.60 |
| 3 | LE1 R2 | −130 | 1.00 | 1.00 | — |
| 4 | QWP R1 | 0 | 2.00 | 1.52 | 58.59 |
| 5 | QWP R2 | 0 | 0.20 | 1.00 | — |
| 6 | PG1 R1 | 0 | 0.45 | 1.52 | 55.00 |
| 7 | PG1 R2 | 0 | 30.00 | 1.00 | — |
| 8 | PG2 R1 | 0 | 0.45 | 1.52 | 55.00 |
| 9 | PG2 R2 | 0 | 20.00 | 1.00 | — |
| 10 | AP | 0 | 1.00 | 1.00 | — |
| 11 | LE2 R1 | 10 | 2.00 | 1.77 | 49.60 |
| 12 | LE2 R2 | −10 | 6.50 | 1.00 | — |
| 13 | IM | 0 | — | 1.00 | — |

TABLE 8

| | X Shift | Y Shift | X Axis | Y Axis |
|---|---|---|---|---|
| | [mm] | [mm] | Rot [deg] | Rot [deg] |
| AL1 | 4.00 | 4.00 | 2.88 | −3.90 |
| AL2 | 4.00 | −4.00 | −2.88 | −3.90 |
| AL3 | −4.00 | 4.00 | 2.88 | 3.90 |
| AL4 | −4.00 | −4.00 | −2.88 | 3.90 |

TABLE 9

| | Diffraction | Lattice | | |
|---|---|---|---|---|
| | Direction | Pitch [um] | Φ1[deg] | Φ2[deg] |
| PG1 | Y | 8.30 | 5.77 | — |
| PG2 | Y | 4.15 | — | −11.52 |

FIG. 11 shows an enlarged view of the optical path of the imaging optical system 1 including the 1-1^{st} order light in numerical example 3. FIG. 11A shows the XZ cross section and FIG. 11B shows the YZ cross section, and both polarized components are listed. In addition, similarly to FIG. 7˜10, the illumination part PJ, the eyes EY1 and EY2, and the half mirror HM are omitted. Both the X direction and the Y direction achieve image formation on the imaging plane IM and near the optical axis.

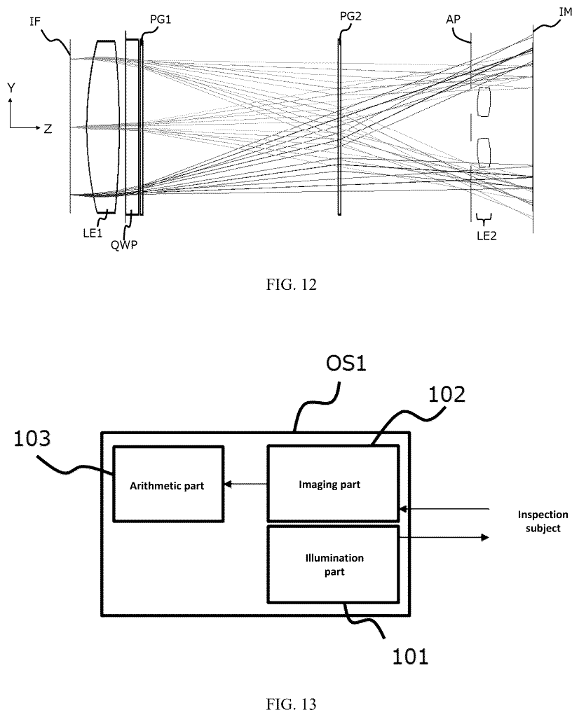

Furthermore, an enlarged view of the optical path of the imaging optical system 1 including the 0-1^{st} order light and the 1-0^{th} order light not required for inspection is shown in FIG. 12. Similar to FIG. 11, both polarized components are listed. Most of the components arrive at positions away from the optical axis and are sufficiently separated for the 1-1^{st} order light required for inspection.

In numerical example 3, it is

$$\frac{{∅}_{1}}{{∅}_{2}} = - 0.5 \frac{{D}_{1}}{{D}_{2}} = 1.02$$

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. Skilled artisans may employ such variations as appropriate, and the present disclosure may be practiced other than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

### REFERENCE NUMBERS

1: Imaging optical system
EY1, EY2: Eye
RE1, RE2: Retina
RY1, RY2: Reflected light from the retina
PG1: First PSD element
PG2: Second PSD element
RY1R, RY1L: Light diffracted by a PSD element

What is claimed is:

1. An imaging optical system for guiding light reflected from a retina to at least one imaging device, the imaging optical system comprising:
a first polarization-selective diffractive (PSD) optical element; and
a second PSD optical element,
wherein the retina, the first PSD optical element, and the second optical PSD element are positioned along an optical path, and
wherein, when emitted by the first PSD optical element, the light is diffracted by a first diffraction angle and, when emitted by the second PSD optical element, the light is diffracted by a second diffraction angle that is opposite to the first angle.

2. The imaging optical system according to claim 1, wherein light in a first polarization state of light incident on the first PSD optical element is diffracted by the first PSD optical element at the first diffraction angle and is emitted in a second polarization state,
wherein light in the second polarization state that is emitted from the first PSD optical element is diffracted by the second PSD optical element at the second diffraction angle, and
wherein the first diffraction angle and the second diffraction angle have opposite signs.

3. The imaging optical system according to claim 1, wherein, in a case where first order light diffracted by the first PSD optical element is incident on the second PSD optical element, first order light diffracted by the second PSD optical element is guided to the at least one imaging device.

4. The imaging optical system according to claim 1, wherein,
$$- 2 < ∅ 1 / ∅ 2 < 0 , .$$
where ø1 is the first diffraction angle and ø2 is the second diffraction angle.

5. The imaging optical system according to claim 1, further comprising:
a first optical system having a positive refractive power; and
a second optical system having a positive refractive power,
wherein the first optical system, the first PSD optical element, the second PSD element, and the second optical system are arranged in order along the optical path.

6. The imaging optical system according to claim 5, further comprising an aperture stop arranged between the second PSD optical element and the second optical system.

7. The imaging optical system according to claim 1, wherein,
$$0.1 < D 1 / D 2 < 2.0 , .$$
where D1 is a distance from a diffraction plane of the first PSD optical element to a diffraction plane of the second PSD optical element and D2 is a distance from a diffraction plane of the second PSD optical element to a light-receiving surface of the at least one imaging device.

8. The imaging optical system according to claim 1, wherein a retinal image of the left eye and a retinal image of the right eye are simultaneously imaged on a light-receiving surface of the at least one imaging device.

9. The imaging optical system according to claim 5, wherein the second optical system is composed of two or more lenses arranged in an array.

10. The imaging optical system according to claim 9, wherein each optical axis of each lens in the array is inclined with respect to an optical axis of the first optical system.

11. The imaging optical system according to claim 1, wherein the imaging optical system is configured to form an intermediate image in the optical path that is conjugate to both the retina and an imaging surface of the at least one imaging device.

12. A measurement device comprising:
the imaging optical system according to claim 11,
wherein the at least one imaging device is positioned along an imaging plane of the imaging optical system.

13. The imaging optical system according to claim 1,
wherein a fixation state of a subject is measured based on signal information of the retina acquired by the at least one imaging device.

14. The measurement device according to claim 12, further comprising an illumination part,
wherein a wavelength of the light illuminated by the illumination part is 800˜900 nm.

15. The measurement device according to claim 13, wherein the illumination part forms an illumination image conjugate to the retina.

16. The measurement device according to claim 1, wherein the optical path forms a substantially straight line.

17. An imaging optical system for guiding light reflected from a retina to at least one imaging device, the imaging optical system comprising:
a first optical system having a positive refractive power;
a first polarization-selective diffractive (PSD) optical element;
a second optical system having a positive refractive power; and
a second PSD optical element,
wherein the retina, the first optical system, the first PSD optical element, the second PSD element, and the second optical system are arranged in order along an optical path.

18. The imaging optical system according to claim 17,
wherein, when emitted by the first PSD optical element, the light is diffracted by a first diffraction angle and, when emitted by the second PSD optical element, the light is diffracted by a second diffraction angle that is opposite to the first angle.

19. The imaging optical system according to claim 17,
wherein an intermediate image is formed in the optical path that is conjugate to both the retina and an imaging surface of the at least one imaging device.

20. The imaging optical system according to claim 17,
wherein a retinal image of the left eye and a retinal image of the right eye are simultaneously imaged on a light-receiving surface of the at least one imaging device.
